(19) United States
(12) Patent Application Publication
(10) Pub. No.: US 2005/0172013 A1
(43) Pub. Date: Aug. 4, 2005

(54) Methods, systems, and computer program products for configuring rules for service nodes in grid service architecture systems

(76) Inventors: Yih-Shin Tan, Raleigh, NC (US); Vivekanand Vellanki, Raleigh, NC (US); Jie Xing, Cary, NC (US)

Correspondence Address: Robert N. Crouse;Myers Bigel Sibley & Sajovec, P.A., P. O. Box 37428, Raleigh, NC, 27627, US

(21) Appl. No.: 10/772,135

(22) Filed: Feb. 4, 2004

(51) Int. Cl. G06F 15/177

(52) U.S. Cl. 709/220

(57) ABSTRACT

Operational rules are transmitted from a first service node that receives a request for service to a second service node that is configured to apply the operational rule to requests for service in response to the request. For example, operational rules can be propagated from a primary node to a secondary node that operates responsive to the primary node, wherein the operational rule defines how the secondary node is to process the request for service from the primary node. Furthermore, the operational rules provided by the primary node can be propagated in a hierarchical fashion throughout the grid to other nodes.

### FIELD OF THE INVENTION

The invention generally relates to the field of information processing and, more particularly, to processing requests for service between nodes.

### BACKGROUND

As the popularity of the Internet has increased, e-business applications have emerged where geographically and organizationally distributed components are expected to operate together. For example, requests for software services can be handled by a distributed network of computer nodes that are owned by different businesses or enterprises. For example, if a first node that is part of a first organization requests service from a second node that is owned by a second organization, the first and second nodes may require detailed information regarding the operation of the other nodes included in a chain of nodes used to provide the service. The second node may be required to understand how the first node operates. Similarly, the first node may be required to understand how the second node operates. Furthermore, each of the nodes in the chain may need to understand how each of the other nodes included in the chain operates. Such an approach can become intractable when, for example, the number of nodes used to provide the service (i.e. the number of nodes in the chain) includes more than a few.

### SUMMARY

Embodiments according to the invention can provide methods, systems, and computer program products for configuring rules for service nodes in grid service architecture systems. In some embodiments according to the invention, operational rules are transmitted from a first service node that receives a request for service to a second service node that is configured to apply the operational rule to requests for service in response to the request. For example, operational rules can be propagated from a primary node to a secondary node that operates responsive to the primary node, wherein the operational rule defines how the secondary node is to process the request for service from the primary node. Furthermore, the operational rules provided by the primary node can be propagated in a hierarchical fashion throughout the grid to other nodes. For example, if a third and fourth level of nodes are registered with the secondary node, the secondary service node can propagate the operational rule provided by the primary node to the third and fourth service nodes.

Accordingly, the details associated with how service requests are to be handled are propagated throughout the grid rather than explicitly defined at each of the service nodes. Therefore, the infrastructure required in the grid can be reduced as the operational rules can be automatically propagated upon registration of service nodes with other service nodes in the grid. In this way, when a new service node enters the grid and requests registration from what will be a primary service node to the new service node, the primary service node can respond by registering the secondary service node and forwarding a set of operational rules that define how the secondary service node is to handle service requests from the primary service node.

In some embodiments according to the invention, the operational rule is propagated from the second service node to a third service node that is registered with the second service node as capable of providing service thereto. In some embodiments according to the invention, transmitting the operational rule is preceded by registering the second node with the first service node to define the second service node as available to the first service node to receive requests for service.

In some embodiments according to the invention, the first operational rule is modified to provide a second operational rule and the second operational rule is transmitted to the second service node responsive to modifying the first operational. rule. In some embodiments according to the invention, a first request for service is received at the first service node and a determination is made that the first request is associated with the operational rule. The operational rule is applied to the first request to provide a propagated first request. The propagated first request is transmitted to the second service node.

In some embodiments according to the invention, a first request for service is received at the first service node. A determination is made that the first request is associated with the operational rule and the operational rule is applied to the first request to provide a propagated first request. The propagated first request is transmitted to a third service node rather than the second service node responsive to a parameter associated with the third service node.

In further embodiments according to the invention, a request for registration is received at a primary service node from a secondary service node including that the secondary service node is capable of providing a service to the primary service node. The secondary service node is registered as being capable of providing the service with primary service node. A response is transmitted from the primary service node to the secondary service node including an operational rule that defines how the service is to be provided to the primary service node. The operational rule is maintained accessible to the secondary service node and associated with the primary service node. A request for service is received from the primary service node at the secondary service node. Service is provided to the primary service node responsive to determining that the request for service is associated with the primary service node.

In further embodiments according to the invention, a system for configuring nodes for service requests includes means for transmitting an operational rule from a first service node that receives a request for service to a second service node that is configured to apply the operational rule to the request for service in response to the request from the first service node for service.

In further embodiments according to the invention, a computer program product for configuring nodes for service requests includes computer readable program code configured to transmit an operational rule from a first service node that receives a request for service to a second service node that is configured to apply the operational rule to the request for service in response to the request from the first service node for service.

### BRIEF DESCRIPTION OF THE DRAWINGS

FIG. 1 is a high-level flow diagram that illustrates methods, systems, and computer program products according to some embodiments of the invention.

FIG. 2 is a hierarchical flow diagram that illustrates methods, systems, and computer program products according to some embodiments of the invention.

FIG. 3 is a hierarchical flow diagram that illustrates methods, systems, and computer program products implementing an address book service according to some embodiments of the invention.

FIG. 4 is a hierarchical flow diagram that illustrates methods, systems, and computer program products implementing business terms and conditions according to some embodiments of the invention.

FIG. 5 is a hierarchical flow diagram that illustrates methods, systems, and computer program products implementing a brokering system according to embodiments of the invention.

### DESCRIPTION OF EMBODIMENTS ACCORDING TO THE INVENTION

The invention is described herein with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers and reference designators refer to like elements throughout.

As will be appreciated by one of skill in the art, the present invention may be embodied as methods, systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

Computer program code or “code” for carrying out operations according to the present invention may be written in an object oriented programming language such as JAVA®, or in various other programming languages. Software embodiments of the present invention do not depend on implementation with a particular programming language. Portions of the code may execute entirely on one or more systems utilized by an intermediary server.

The code may execute entirely on one or more servers, or it may execute partly on a server and partly on a client within a client device or as a proxy server at an intermediate point in a communications network. In the latter scenario, the client device may be connected to a server over a LAN or a WAN (e.g., an intranet), or the connection may be made through the Internet (e.g., via an Internet Service Provider). It is understood that the present invention is not TCP/IP-specific or Internet-specific. The present invention may be embodied using various protocols over various types of computer networks.

The invention is described below with reference to diagram illustrations of methods, systems and computer program products according to embodiments of the invention. It is understood that each block shown in the diagrams (i.e., block diagram and/or flowchart diagram), and combinations of blocks in the diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the diagram block or blocks.

These computer program instructions may be stored in a computer-readable memory that can direct a computer or other programmable data processing apparatus to function in a particular manner, such that the instructions stored in the computer-readable memory produce an article of manufacture including instruction means which implement the function specified in the diagram block or blocks.

The computer program instructions may be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the diagram block or blocks.

Embodiments according to the invention can operate within what is sometimes referred to as an Open Grid Services Architecture (OGSA). In an OGSA system, world-wide-web, (i.e. Web) services can provide a framework for application-to-application interaction that grants access to services via the Internet. These services can allow a more extensive use of the Web's functionality by supporting automatic processes involving machine-to-machine cooperation and interaction. The infrastructure used to provide these services (as well as data) is sometimes referred to as a “grid.” As used herein, a grid can be a geographically distributed set of heterogeneous machines that are configured to communicate with one another via a network (such as the Internet). The heterogeneous machines that provide services in the grid are sometimes referred to as service nodes. In operation, a service node within the grid can request service from another service node within the grid. Furthermore, the service node to which this request for service is made can propagate the request to yet other service nodes within the grid, which ultimately results in the requested service being provided to the requesting node. OGSA, and grid architecture in general, is described further, for example, on the Internet at www.globus.org, the contents of which are incorporated herein by reference. In particular, the Globus Alliance has published various articles and presentations which discuss the infrastructure and architecture. One such article published by Globus (and also available on the Internet) is entitled The Physiology of the Grid and is available at www.globus.org/OGSA/, the contents of which are incorporated herein by reference. Other Globus articles are also available on the Internet generally and specifically at the above website.

Embodiments according to the invention are described herein using the terms “primary” and “secondary”, “third level”, “fourth level”, and the like to describe the hierarchical relationships between service nodes. It will be understood that the these terms may are not used in an absolute sense. For example, if a first service node is described as being a primary node whereas a second service node is described as a secondary node, the first and second nodes can be at any levels within the grid as long as the first service node is at a higher hierarchical level than the second service node.

Embodiments according to the invention can provide methods, systems, and computer program products for configuring rules for service nodes in grid service architecture systems. In some embodiments according to the invention, operational rules are transmitted from a first service node that receives a request for service to a second service node that is configured to apply the operational rule to requests for service in response to the request. For example, operational rules can be propagated from a primary node to a secondary node that operates responsive to the primary node, wherein the operational rule defines how the secondary node is to process the request for service from the primary node. Furthermore, the operational rules provided by the primary node can be propagated in a hierarchical fashion throughout the grid to other nodes. For example, if a third and fourth level of nodes are registered with the secondary node, the secondary service node can propagate the operational rule provided by the primary node to the third and fourth service nodes.

Accordingly, the details associated with how service requests are to be handled are propagated throughout the grid rather than explicitly defined at each of the service nodes. Therefore, the infrastructure required in the grid can be reduced as the operational rules can be automatically propagated upon registration of service nodes with other service nodes in the grid. In this way, when a new service node enters the grid and requests registration from what will be a primary service node to the new service node, the primary service node can respond by registering the secondary service node and forwarding a set of operational rules that define how the secondary service node is to handle service requests from the primary service node.

Furthermore, as described briefly above, the new service node may propagate the operational rules received from the primary node to other nodes that operate responsive to the new service node. It will be understood that ultimately, service nodes access service providers within the grid so that the services requested by the primary node can by provided. As used herein the service providers can be applications that provide data, such as address information, pricing information, etc. Accordingly, the service nodes that have a direct interface to the service providers will maintain information as to how to communicate with the service providers so that the requested services are provided.

Locating this information regarding control of the service providers may avoid having to propagate this type of specific information to every node within the grid which may need to access the particular service provider. Moreover, the service provider can be added to the grid with the service node that communicates with the new service provider (i.e., as a pair). When the new service node registers with an existing service node in the grid (i.e., a service node that is primary to the new service node) to introduce new services to the grid, the services will be available to the other service nodes in the grid via the primary service node with which the new service node is registered.

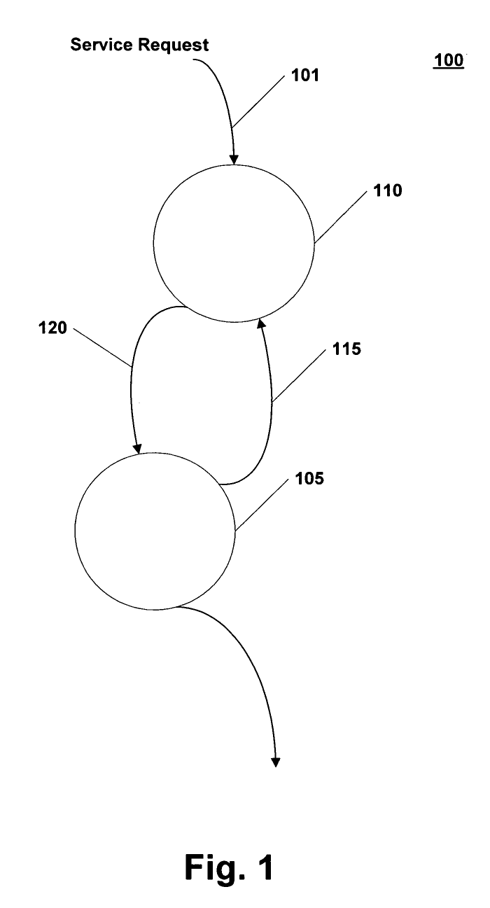

FIG. 1 is a high-level flow diagram that illustrates operations of methods, systems, and computer program products according to embodiments of the invention. In particular, a primary service node 110 can receive service requests 101 from users in a grid 100. A secondary service node 105 is made available to the grid 100 by requesting registration with the primary service node 110. In particular, the secondary service node 105 issues a request for registration 115 to the primary service node 110 which responds by recording that the secondary node 105 is available and capable of providing services to the primary service node 110. Although only two service nodes are shown in FIG. 1, it will be understood that the grid 100 may include any number of service nodes.

The primary service node 110 also transmits operational rules 120 to the secondary service node 105 that define how the secondary service node 105 is to handle service requests from the primary service node 110. For example, the operational rules can specify how services are to be provided when the secondary service node 105 determines that the service request has been issued by the primary service node 110 rather than another primary service node with which the secondary service node 105 is also registered. In some embodiments according to the invention, the operational rules can include pricing information, geographic information, specific information related to which service provider to use, and the like. For example, in some embodiments according to the invention, the operational rule can be price range information that can be used to determine which service provider to use based on a particular price point provided by a user included with the request 101 to the primary service node 110.

It will be further understood that the operational rules provided by the primary service node 110 can be further transmitted by the secondary service node 105 to propagate the operational rules throughout the grid 100 in general, and more particularly, to service nodes that operate responsive to the secondary service node 105. It will further be understood that the operational rules can be distinguished from parameters that are specified by part of the requests 105 for service made by the user. For example, in some requests, the user may specify a particular type of car for which pricing information is sought or a particular car buying service which is to be queried rather than an operational rule which defines how the service request is to be processed such as to which service nodes the request will be forwarded for ultimate service using the parameters specified by the user.

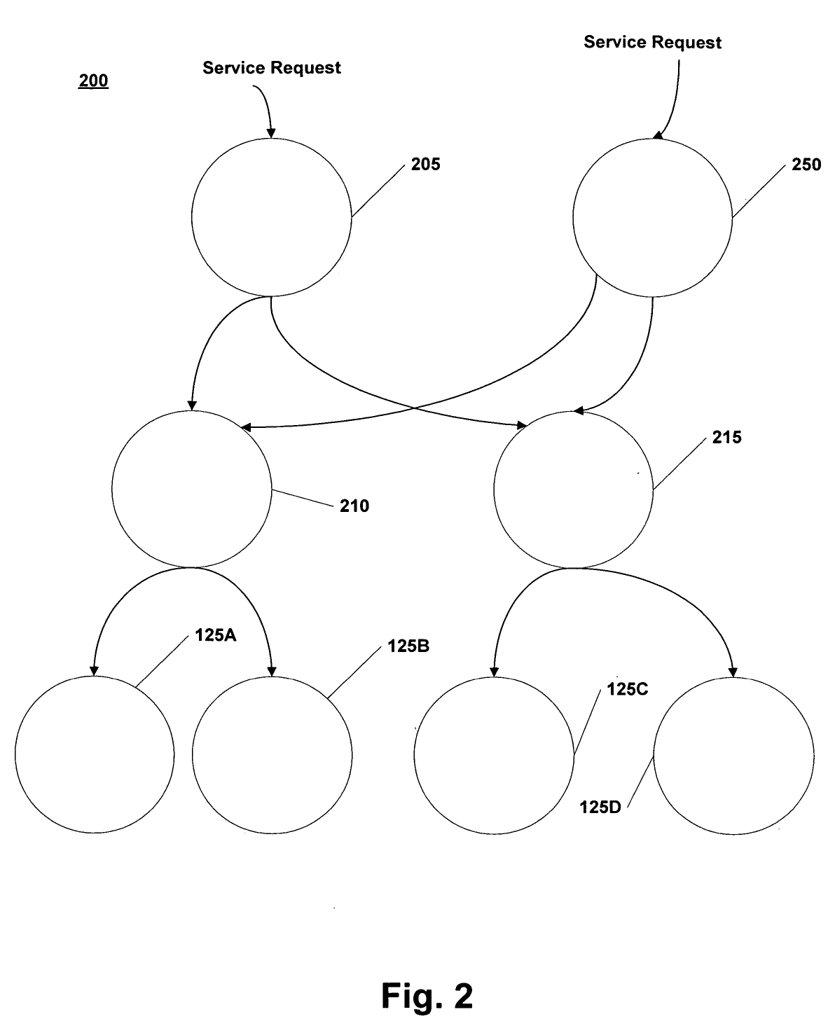

FIG. 2 is a flow diagram that illustrates operations of methods, systems, and computer program products according to embodiments of the invention. In particular, FIG. 2 illustrates first and second primary service nodes 205 and 250, respectively, with which different secondary service nodes are registered in a grid 200. As shown in FIG. 2, a first secondary service node 210 is registered with the first and second primary service nodes 205 and 250. Furthermore, a second secondary service node 215 is also registered with the first and second primary service nodes 205 and 250. According to some embodiments of the invention, the first and second secondary service nodes 210 and 215 can operate using different operational rules that are provided by the first and second primary service nodes 205 and 250. Furthermore, the first secondary service node 210 has the first and second third-level service nodes 125A and 125B registered whereas third and fourth third-level service nodes 125C and 125D are registered with the second secondary service node 215. Accordingly, the secondary and third-level service nodes may process service requests from the first and second primary service nodes 205 and 250 differently in accordance with the different operational rules provided. For example, in some embodiments according to the invention illustrated by FIG. 2 where the system provides a sales grid environment, the secondary service node 210 may operate under a first operational rule provided by the first primary service node 205 wherein any request received from the first primary service node 205 is to be provided with a discount of $500.00. In contrast, the secondary service node 210 may operate under a rule that applies a $1,000.00 discount to any service request received from the second primary service node 250. Furthermore, as discussed above, these different operational rules can be propagated to the third-level service nodes that are registered with the first secondary service node 210.

As further shown in FIG. 2, users may interact with one or both of the primary service nodes 205 and 250 but receive services under different terms and conditions such as the different discounts described above. In other embodiments according to the invention, the rules propagated from the primary service nodes 205 and 250 can specify that services are to be provided on a round-robin basis. For example, a service request provided to the first secondary service node 210 may be handled on a round-robin basis such that the services are provided on an alternating basis by third-level's service nodes 125A and 125B.

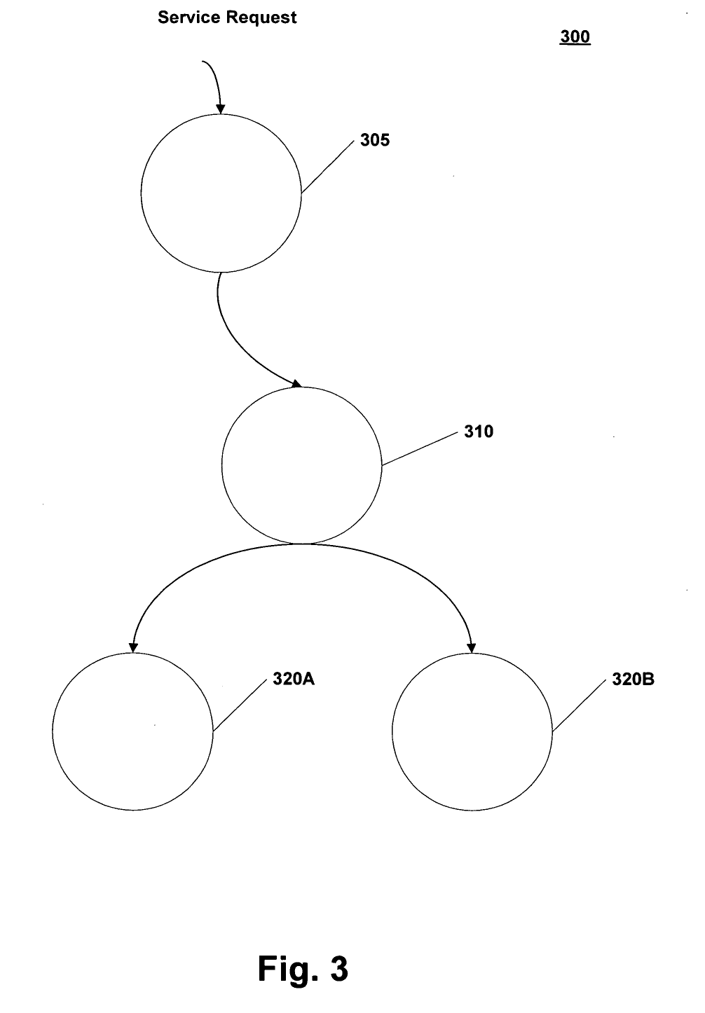

FIG. 3 is a flow diagram that illustrates operations of methods, systems, and computer program products according to embodiments of the invention. In particular, a service grid 300 provides an address book service wherein different users: A and B, can store and retrieve address information. In operation, User A, for example, can issue requests to store address book information (such as names and telephone numbers) to a primary service node 305. The primary service node 305 has propagated an operational rule to a secondary service node 310 that specifies that address book service request 335 from the primary service node 305 are to be provided so that the secondary service node 310 maintains an identifier associated with the user that made the request for address book service. In particular, once address book service is established with a particular service provider for a particular user of the address book service, subsequent requests for storing and retrieving address book information should be directed to the same address book service. For example, if the secondary service node 310 initially provides address book service for User A using address book service A via a third-level service node 320A, all subsequent requests for storing and retrieving address book information made by User A to the primary service node 305 will be similarly directed to the service node 320A by the secondary service node 310. It will be understood that other users address book service requests can be provided by other address book services, such as address book service B via a third-level service node 320B which is also registered with the secondary service node 310.

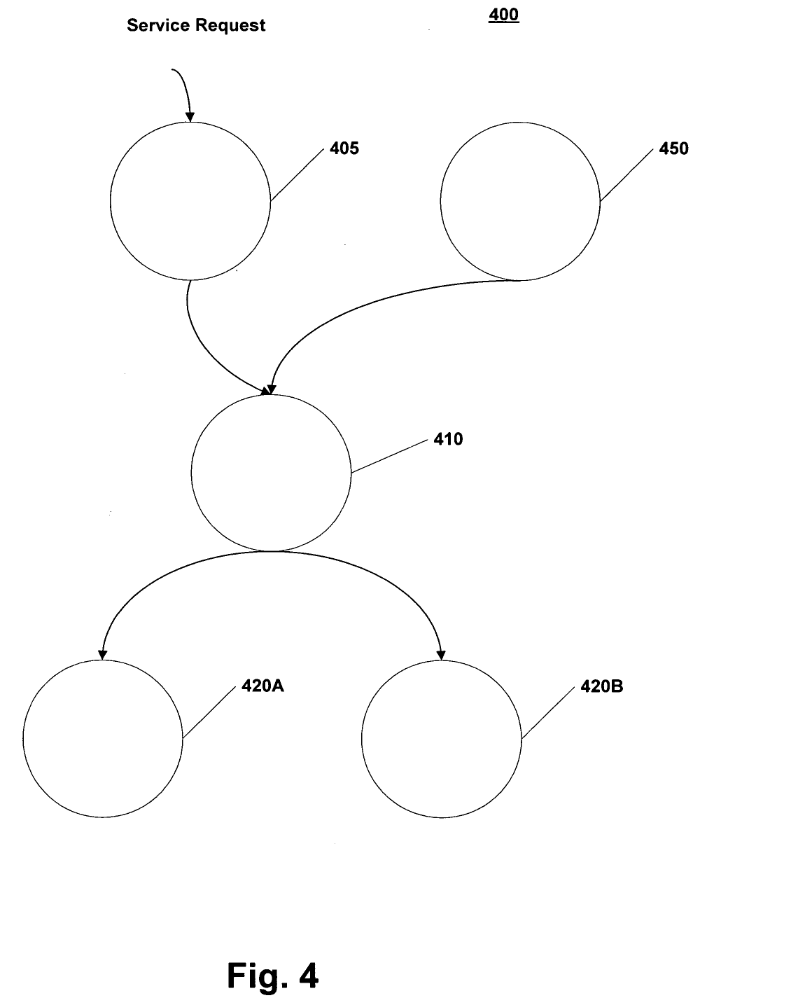

FIG. 4 is a flow diagram that illustrates operations of methods, systems, and computer program products according to embodiments of the invention. In particular, a service grid 400 illustrates how operational rules can reflect different business terms and conditions associated with different service providers. In some embodiments according to the invention, the service grid 400 shown in FIG. 4 can provide service for insurance claims made by employees of different employers represented by first and second primary service nodes 405 and 450. A secondary service node 410 is registered with both the first and second primary service nodes 405 and 450. Furthermore, the secondary service node 410 includes operational rules (propagated by the first and second primary service nodes 405 and 450) for handling requests made by the different primary service nodes. For example, if a request for service is made by Employee A of a company represented by the first primary service node 405, the secondary service node 410 can apply a rule that limits the coverage of the claim to $500.00 whereas the secondary service node 410 can apply a second operational rule that applies a coverage limit of $1,000.00 to service requests made by employees of a company represented by the second primary service node 450.

It will further be understood that new rules can be propagated by the first and second primary service nodes 405 and 450 based on changes introduced by the different employers. For example, if the employer represented by the first primary service node 405 increases the coverage for employees from $500.00 to $1,000.00, the new rule can be propagated from the first primary service node 405 to the secondary service node 410 so that subsequent requests for service are handled according to the updated operational rule associated with the first primary service node 405. In other embodiments according to the invention, the service grid 400 can provide additional operational rules such as security rules or error recovery rules. One example of an operational security rule is where the secondary service node 410 is registered with the first and second primary service nodes 405 and 450 as a trusted node, which may avoid requiring service requests from first and second primary service nodes 405 and 450 having to be authenticated. In some embodiments according to the invention where the service grid 400 provides error recovery, the secondary service node 410 may apply an operational rule that specifies that service is to be requested from a third-level service node 420A a certain number of times before making another request for service to a second third-level service node 420B. It will be understood that although the rules described above are discussed in reference to different embodiments, each of the embodiments can include combinations of the operational rules rather than only selected or individual rules. For example, in some embodiments according to the invention, the service grid 400 shown in FIG. 4 may include terms and conditions, security rules, error recovery rules, and other types of rules discussed herein. Furthermore, it will be understood that not all operational rules may be propagated to the same degree as other operational rules. For example, in some embodiments according to the invention, some operational rules may be propagated only up to the secondary service node 420 whereas other operational rules may be propagated to the third-level service nodes 420A and 420B (or beyond if greater hierarchy exists).

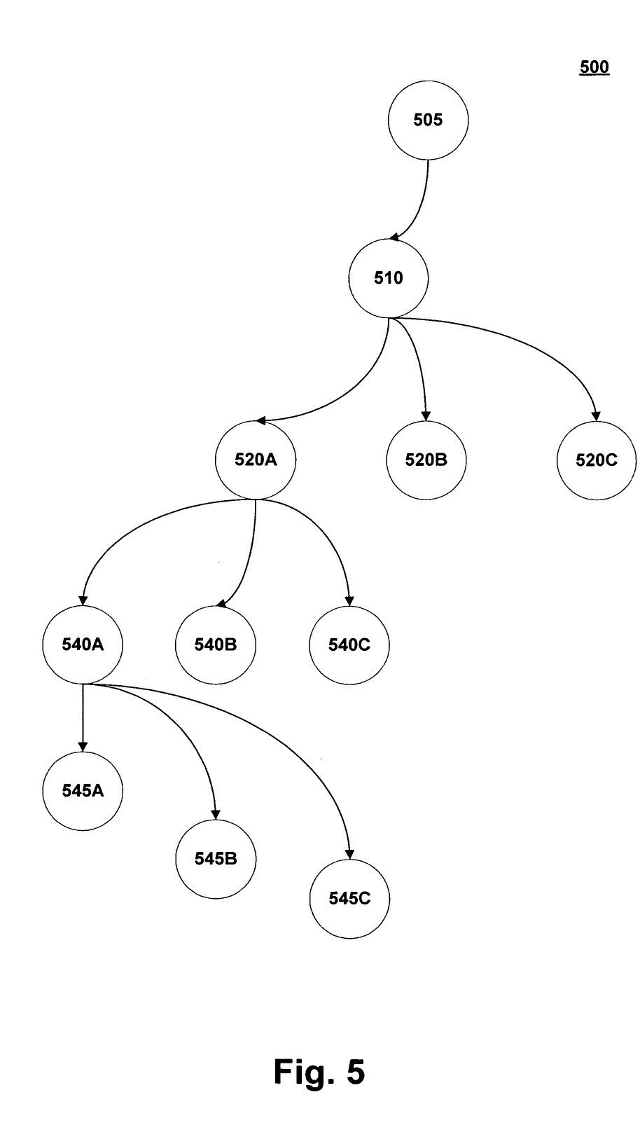

FIG. 5 is a flow diagram that illustrates operations of methods, systems, and computer program products according to embodiments of the invention. In particular, a service grid 500 shown in FIG. 5 illustrates a car buying or information service wherein users request, for example, car price or availability information from a primary service node 505 which causes the request to, ultimately, be provided to the service providers 545A-C via the grid 500. According to FIG. 5, operational rules are propagated from the primary service node 505 to the secondary service node 510 which is registered therewith. Some of the operational rules propagated to the secondary service node 510 can include price ranges for particular cars of interest representing low, mid-price, and luxury models. For example, some of the operational rules maintained by the secondary service node 510 can specify that if the budget for a request from the primary service node 505 falls within a low price range, the secondary service node 510 forwards the service request to a third-level service node 520A that is designated as servicing requests for information regarding low priced cars. Similarly, other third-level service nodes 520B and 520C can be designated as handling requests that fall into mid-price and luxury price ranges respectively.

Referring again to the low-price range requests handled by the third-level service node 520A, the service request can be forwarded to nodes registered with the third-level service node 520A based on tokens that can be included with the request submitted by the primary service node 505. For example, some of the tokens included with the request can include a particular leased price or a latest model that specifies that only information for cars having a lease price are to be provided or only information regarding the latest models cars are to be provided. In other embodiments according to the invention, the token can include a geographic location preferred by the user, such as a northeast region, a southern region, or a western region. As shown in FIG. 5, if the request includes a northeastern region token, the request is forwarded to a fourth-level service node 540A. Alternatively, if the token included with the service request specifies a midwest geographic region or a western geographic region, the request can be forwarded to other fourth-level service nodes 540B and 540C, respectively.

The fourth-level service node 540A can operate on the service request based on an operational rule and is propagated by the primary service node 505, such as a round robin operational rule that specifies that among the northeast region service providers, information on cars are to be provided from service providers on a round robin basis. For example, on a first service request, information is provided from a first fifth-level service node 545A whereas subsequent requests are provided by other ones of the fifth-level service nodes.

As described above, embodiments according to the invention can provide methods, systems, and computer program products for configuring rules for service nodes in grid service architecture systems. In some embodiments according to the invention, operational rules are transmitted from a first service node that receives a request for service to a second service node that is configured to apply the operational rule to requests for service in response to the request. For example, operational rules can be propagated from a primary node to a secondary node that operates responsive to the primary node, wherein the operational rule defines how the secondary node is to process the request for service from the primary node. Furthermore, the operational rules provided by the primary node can be propagated in a hierarchical fashion throughout the grid to other nodes. For example, if a third and fourth level of nodes are registered with the secondary node, the secondary service node can propagate the operational rule provided by the primary node to the third and fourth service nodes.

Accordingly, the details associated with how service requests are to be handled are propagated throughout the grid rather than explicitly defined at each of the service nodes. Therefore, the infrastructure required in the grid can be reduced as the operational rules can be automatically propagated upon registration of service nodes with other service nodes in the grid. In this way, when a new service node enters the grid and requests registration from what will be a primary service node to the new service node, the primary service node can respond by registering the secondary service node and forwarding a set of operational rules that define how the secondary service node is to handle service requests from the primary service node.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A method of configuring nodes for service requests, the method comprising:
transmitting an operational rule from a first service node that receives a request for service to a second service node that is configured to apply the operational rule to the request for service in response to the request from the first service node for service.

2. A method according to claim 1 further comprising:
propagating the operational rule from the second service node to a third service node that is registered with the second service node as capable of providing service thereto.

3. A method according to claim 1 wherein transmitting an operational rule is preceded by:
registering the second node with the first service node to define the second service node as available to the first service node to receive requests for service.

4. A method according to claim 1 wherein the operational rule comprises a first operational rule, the method further comprising:
modifying the first operational rule to provide a second operational rule; and
transmitting the second operational rule to the second service node responsive to modifying the first operational rule.

5. A method according to claim 1 further comprising:
receiving a first request for service at the first service node;
determining that the first request is associated with the operational rule;
applying the operational rule to the first request to provide a propagated first request; and
transmitting the propagated first request to the second service node.

6. A method according to claim 1 further comprising:
receiving a first request for service at the first service node;
determining that the first request is associated with the operational rule;
applying the operational rule to the first request to provide a propagated first request; and
transmitting the propagated first request to a third service node rather than the second service node responsive to a parameter associated with the third service node.

7. A method according to claim 1 further comprising:
receiving a first request for service at the first service node, the first request for service including a token associated with the first request that further defines how the first request is to be serviced;
determining that the first request is associated with the operational rule;
applying the operational rule to the first request to provide a propagated first request; and
transmitting the propagated first request and the token to the second service node.

8. A method according to claim 7 wherein the token comprises at least one of a price, geographic location, and quality of service.

9. A method according to claim 1 wherein the operational rule comprises a rule associated with at least one of security, error recovery, and business transaction terms/conditions associated with the request for service.

10. A method according to claim 1 wherein the operational rule comprises an requestor identifier that identifies a the first service node as transmitting the request for service the second service node.

11. A method of configuring secondary service nodes to handle service requests from a primary service node in a service node network, the method comprising:
receiving a request for registration at a primary service node from a secondary service node including that the secondary service node is capable of providing a service to the primary service node;
registering that the secondary service node is capable of providing the service with primary service node;
transmitting a response from the primary service node to the secondary service node including an operational rule that defines how the service is to be provided to the primary service node;
maintaining the operational rule accessible to the secondary service node and associated with the primary service node;
receiving a request for service from the primary service node at the secondary service node; and
providing service to the primary service node responsive to determining that the request for service is associated with the primary service node.

12. A method according to claim 11 wherein the primary node comprises a first primary node and the operational rule comprises a first operational rule, the method further comprising:
receiving a request for registration at a second primary service node from the secondary service node including that the secondary service node is capable of providing service to the second primary service node;
registering that the secondary service node is capable of providing the service with second primary service node;
transmitting a response from the second primary service node to the secondary service node including a second operational rule that defines how the service is to be provided to the second primary service node;
maintaining the second operational rule accessible to the secondary service node and associated with the second primary service node;
receiving a request for service from the second primary service node at the secondary service node; and
providing service to the second primary service node using the second operational rule responsive to determining that the request for service is associated with the second primary service node.

13. A system for configuring nodes for service requests, comprising:
means for transmitting an operational rule from a first service node that receives a request for service to a second service node that is configured to apply the operational rule to the request for service in response to the request from the first service node for service.

14. A system according to claim 13 further comprising:
means for propagating the operational rule from the second service node to a third service node that is registered with the second service node as capable of providing service thereto.

15. A system according to claim 13 further comprising:
means for registering the second node with the first service node to define the second service node as available to the first service node to receive requests for service.

16. A system according to claim 13 wherein the operational rule comprises a first operational rule, the system further comprising:
means for modifying the first operational rule to provide a second operational rule; and
means for transmitting the second operational rule to the second service node responsive to modifying the first operational rule.

17. A system according to claim 13 further comprising:
means for receiving a first request for service at the first service node;
means for determining that the first request is associated with the operational rule;
means for applying the operational rule to the first request to provide a propagated first request; and
means for transmitting the propagated first request to the second service node.

18. A system according to claim 13 further comprising:
means for receiving a first request for service at the first service node;
means for determining that the first request is associated with the operational rule;
means for applying the operational rule to the first request to provide a propagated first request; and
means for transmitting the propagated first request to a third service node rather than the second service node responsive to a parameter associated with the third service node.

19. A system according to claim 13 further comprising:
means for receiving a first request for service at the first service node, the first request for service including a token associated with the first request that further defines how the first request is to be serviced;
means for determining that the first request is associated with the operational rule;
means for applying the operational rule to the first request to provide a propagated first request; and
means for transmitting the propagated first request and the token to the second service node.

20. A system according to claim 19. wherein the token comprises at least one of a price, geographic location, and quality of service.

21. A system according to claim 13 wherein the operational rule comprises a rule associated with at least one of security, error recovery, and business transaction terms/conditions associated with the request for service.

22. A system according to claim 13 wherein the operational rule comprises a requestor identifier that identifies a the first service node as transmitting the request for service the second service node.

23. A system for configuring secondary service nodes to handle service requests from a primary service node in a service node network, comprising:
means for receiving a request for registration at a primary service node from a secondary service node including that the secondary service node is capable of providing a service to the primary service node;
means for registering that the secondary service node is capable of providing the service with primary service node;
means for transmitting a response from the primary service node to the secondary service node including an operational rule that defines how the service is to be provided to the primary service node;
means for maintaining the operational rule accessible to the secondary service node and associated with the primary service node;
means for receiving a request for service from the primary service node at the secondary service node; and
means for providing service to the primary service node responsive to determining that the request for service is associated with the primary service node.

24. A system according to claim 23 wherein the primary node comprises a first primary node and the operational rule comprises a first operational rule, the system further comprising:
means for receiving a request for registration at a second primary service node from the secondary service node including that the secondary service node is capable of providing service to the second primary service node;
means for registering that the secondary service node is capable of providing the service with second primary service node;
means for transmitting a response from the second primary service node to the secondary service node including a second operational rule that defines how the service is to be provided to the second primary service node;
means for maintaining the second operational rule accessible to the secondary service node and associated with the second primary service node;
means for receiving a request for service from the second primary service node at the secondary service node; and
means for providing service to the second primary service node using the second operational rule responsive to determining that the request for service is associated with the second primary service node.

25. A computer program product for configuring nodes for service requests comprising:
a computer readable medium having computer readable program code embodied therein, the computer readable program product comprising:
computer readable program code configured to transmit an operational rule from a first service node that receives a request for service to a second service node that is configured to apply the operational rule to the request for service in response to the request from the first service node for service.

26. A computer program product according to claim 25 further comprising:
computer readable program code configured to propagate the operational rule from the second service node to a third service node that is registered with the second service node as capable of providing service thereto.

27. A computer program product according to claim 25 further comprising: computer readable program code configured to register the second node with the first service node to define the second service node as available to the first service node to receive requests for service.

28. A computer program product according to claim 25 wherein the operational rule comprises a first operational rule, the computer program product further comprising:
computer readable program code configured to modify the first operational rule to provide a second operational rule; and
computer readable program code configured to transmit the second operational rule to the second service node responsive to modifying the first operational rule.

29. A computer program product according to claim 25 further comprising:
computer readable program code configured to receiving a first request for service at the first service node;
computer readable program code configured to determine that the first request is associated with the operational rule;
computer readable program code configured to apply the operational rule to the first request to provide a propagated first request; and
computer readable program code configured to transmit the propagated first request to the second service node.

30. A computer program product according to claim 25 further comprising:
computer readable program code configured to receive a first request for service at the first service node;
computer readable program code configured to determine that the first request is associated with the operational rule;
computer readable program code configured to apply the operational rule to the first request to provide a propagated first request; and
computer readable program code configured to transmit the propagated first request to a third service node rather than the second service node responsive to a parameter associated with the third service node.

31. A computer program product according to claim 25 further comprising:
computer readable program code configured to receive a first request for service at the first service node, the first request for service including a token associated with the first request that further defines how the first request is to be serviced;
computer readable program code configured to determine that the first request is associated with the operational rule;
computer readable program code configured to apply the operational rule to the first request to provide a propagated first request; and
computer readable program code configured to transmit the propagated first request and the token to the second service node.

32. A computer program product according to claim 31 wherein the token comprises at least one of a price, geographic location, and quality of service.

33. A computer program product according to claim 25 wherein the operational rule comprises a rule associated with at least one of security, error recovery, and business transaction terms/conditions associated with the request for service.

34. A computer program product according to claim 25 wherein the operational rule comprises a requestor identifier that identifies a the first service node as transmitting the request for service the second service node.

35. A computer program product of configuring secondary service nodes to handle service requests from a primary service node in a service node network, comprising:
a computer readable medium having computer readable program code embodied therein, the computer readable program product comprising:
computer readable program code configured to receive a request for registration at a primary service node from a secondary service node including that the secondary service node is capable of providing a service to the primary service node;
computer readable program code configured to register that the secondary service node is capable of providing the service with primary service node;
computer readable program code configured to transmit a response from the primary service node to the secondary service node including an operational rule that defines how the service is to be provided to the primary service node;
computer readable program code configured to maintain the operational rule accessible to the secondary service node and associated with the primary service node;
computer readable program code configured to receive a request for service from the primary service node at the secondary service node; and
computer readable program code configured to provide service to the primary service node responsive to determining that the request for service is associated with the primary service node.

36. A computer program product according to claim 35 wherein the primary node comprises a first primary node and the operational rule comprises a first operational rule, the computer program product further comprising:
computer readable program code configured to receive a request for registration at a second primary service node from the secondary service node including that the secondary service node is capable of providing service to the second primary service node;
computer readable program code configured to register that the secondary service node is capable of providing the service with second primary service node;
computer readable program code configured to transmitting a response from the second primary service node to the secondary service node including a second operational rule that defines how the service is to be provided to the second primary service node;
computer readable program code configured to maintain the second operational rule accessible to the secondary service node and associated with the second primary service node;
computer readable program code configured to receive a request for service from the second primary service node at the secondary service node; and
computer readable program code configured to provide service to the second primary service node using the second operational rule responsive to determining that the request for service is associated with the second primary service node.
